(19) United States
(12) Patent Application Publication
(10) Pub. No.: US 2018/0314126 A1
(43) Pub. Date: Nov. 1, 2018

(54) Display Device for Displaying a Selection of Permanently Specified Display Elements

(71) Applicant: Biegert & Funk Product GmbH & Co. KG, Schwaebisch Gmuend (DE)

(72) Inventors: Marco Biegert, Schwaebisch Gmuend (DE); Andreas Funk, Schwaebisch Gmuend (DE)

(21) Appl. No.: 15/956,126

(22) Filed: Apr. 18, 2018

(30) Foreign Application Priority Data
Apr. 28, 2017 (EP) 17168688.4

(51) Int. Cl. G02F 1/167; G09G 3/04; G09G 3/34

(52) U.S. Cl. CPC G02F 1/167; G09G 3/045; G02F 2001/1678; G02F 2001/1672; G09G 3/344

(57) ABSTRACT

A display device for displaying a selection of permanently specified display elements with
a front panel that has a plurality of windows that form a number of permanently specified display elements,
an electrophoretic electronic paper that is arranged behind the front panel so that a partial surface of the electronic paper is assigned to each of the windows, and
an electronic control with which a degree of reflection of the electronic paper can be set for each of the partial surfaces.

The invention relates to a display device for displaying a selection of permanently specified display elements. Such display devices are utilized for special display tasks to which they are constructively adapted. In contrast to universally utilizable display devices such as, for example, computer screens, they can only display permanently specified display elements. Certain contents can be displayed in that a certain selection is made from the permanently specified display elements and is visually highlighted.

An example of such a display device is found in the document DE 20 2009 017 703 U1 in which a word clock is described that displays the current time in words. It has a front panel with a plurality of cut-outs arranged in a rectangular matrix that each form an individual letter. Behind the front panel, in a grid corresponding to the rectangular matrix, light sources in the form of LEDs are arranged that each light up one of the letters. By activating these LEDs, a selection of the letters can be highlighted that forms a sentence that describes the current time. The known display device offers numerous configuration possibilities, in particular with regard to the front panel. These can be manufactured from a material that is unsuitable for conventional display devices, for example from corroded steel.

From the document US 2006/0198629 A1, an IC card is known that has an integrated circuit and a display device with which contents saved on the card can be displayed. The display unit has a wall element with gaps and injection canals into which a cholesteric liquid crystal material is injected. On an underside of the wall element there are a common electrode and a substrate layer. On the opposite top side of the wall element, segment electrodes corresponding to the gaps are arranged. On the top side of the wall element there is a shadow mask to cover the injection canals and edge regions of the segment electrodes.

From the document US 2002/0036616 A1, a display device is known with an electronic paper and a circuit for refreshing the pixels of the electronic paper.

From the document DE 690 13 233 T2, an IC card is known that has a 16-digit display device. Each digit consists of a 5×7 dot matrix. The display device can be utilized to display the time, among other things.

Starting from this, it is the object of the invention to provide an improved display device for displaying a selection of permanently specified display elements.

This object is solved by the display device with the features of claim 1. Advantageous embodiments are indicated in the dependent claims.

The display device serves to display a selection of permanently specified display elements and has
a front panel that has a plurality of windows that form a number of permanently specified display elements,
an electrophoretic electronic paper that is arranged behind the front panel so that a partial surface of the electronic paper is assigned to each of the windows, and
an electronic control with which a degree of reflection of the electronic paper can be set.

The front panel informs the appearance of the display device to a significant degree. It can in particular be made of a material that is unusual for conventional displays, such as wood, ceramic, plastic or metal. In the regions of the windows, the front panel is transparent so that the partial surfaces of the electronic paper arranged behind the windows are visible from the front side of the display device. The transparency in the region of the windows can be achieved in different ways, for example by not, or only weakly, dyeing a front panel made from a plastic material in the region of the windows, or by utilizing transparent elements in an otherwise non-transparent front panel in the region of the windows. The windows form a number of permanently specified display elements. These display elements are permanently specified in as far as the arrangement and shape of the windows is designed during the production of the front panel and subsequently cannot be changed. All of the windows together form the available supply of display elements. Each display element can be formed from one or more windows and each display element can be displayed independently from one or more further display elements.

The electrophoretic electronic paper is a so-called passive, meaning not itself shining, display that reflects the light similarly to normal, printed paper. Electronic paper, in conformity with the English linguistic usage, is also referred to as a reflective display or, in conformity with the brand name of a known manufacturer, as an E Ink display. The electronic paper can have a thickness similar to paper in the range of, for example, 50 μm to 1 mm. Electronic paper is used primarily in reading devices for electronic books, so-called e-book readers. The technology behind the electrophoretic electronic paper is based on the effect of electrophoresis. Electrophoresis refers in general to a migration of charged colloidal particles or dissolved molecules caused by an electric field. The electrophoretic paper uses this effect to set different reflection characteristics by deliberately influencing the arrangement of electrically charged particles.

For example, the electronic paper can have numerous micro-capsules with an average diameter of, for example, approximately 40 μm that contain positively charged white particles and negatively charged black particles in a transparent, viscous polymer. A use of particles with different colors, for example red, green and blue, is also possible so that different colors can also be represented. By applying an electrical voltage for a short time, the arrangement of the differently colored particles in the micro-capsules is influenced so that a nearly white or nearly black surface becomes visible on a side of the electronic paper facing the viewer in the region of the respective micro-capsule, or a surface with a color or shade of gray determined by the mixture of the colors of different micro-capsules or particles. It is also possible to utilize only particles with exactly one certain color or brightness, wherein different degrees of reflection then arise in combination with the surrounding medium or a background. Electrophoretic electronic papers are also known with a surface on which, in the event of a certain arrangement of charged particles, a total reflection appears that is prevented by a shift of the particles to another position.

In order to activate the electronic paper in the outlined way, it has passive transparent electrodes or, for example, a TFT active matrix. As an alternative to the electrophoresis, other techniques are known with which displays are made that imitate the appearance of conventional paper. In the following, these are included in the concept “electronic paper.”

In the invention, the electronic paper is arranged behind the front panel. Partial surfaces of the electronic paper are therefore visible through the windows from a front side of the display device. In this sense, a partial surface of the electronic paper is assigned to each of the windows. The display elements or respectively the windows can be arranged distributed over a greater part of the surface of the front panel. The display elements or respectively the windows can be arranged irregularly and/or grouped. The display elements or respectively the windows can in particular be arranged in a rectangular grid so that they form rows and columns of a matrix.

The display device has an electronic control with which a degree of reflection of the electronic paper can be set for each of the partial surfaces. The degree of reflection is a measure of the intensity of the (diffuse and mirrored) reflected light averaged over the entire wavelength range of the visible light. Therefore, the appearance of each display element can be set by setting the degree of reflection of the electronic paper in the region behind the associated window. This makes it possible to make a selection from the entirety of the permanently specified display elements that is highlighted relative to the remaining display elements.

By using the electronic paper, a possibility is created of highlighting a selection of the display elements relative to other, non-selected display elements without a light source being necessary for this. A radiation of light by the display device that is undesired in many situations, such as when using a display device in a bedroom, is thereby avoided. However, the highlighted display elements can be distinguished clearly from the non-highlighted display elements, even with bright surrounding light. A further advantage is the very low energy consumption of the electronic paper in comparison to the use of LEDs to illuminate the individual display elements. In particular, a battery operation of the display device over longer periods of times is thereby enabled.

In contrast to conventional displays, such as computer screens or the mentioned e-book readers, the invention is distinguished in that the outlines of the display elements are defined by the windows of the front panel exactly and with high edge definition. There is no limiting of a contour definition, for example incremental or jagged oblique lines, as a result of the resolution of the electronic paper. A very high design quality of the display elements is thereby achieved.

In one embodiment, the front panel is made of a non-transparent material or the front panel has a layer of a non-transparent material, wherein the windows are cut-outs in the non-transparent material. In the region of the cut-outs, there is accordingly no non-transparent material present. For example, a front panel made of metal, for example aluminum, copper or stainless steel, can be provided with laser-cut cut-outs that form the windows. A multi-layer construction of the front panel, in particular with a glass or acrylic glass plate forming the front side of the front panel, is also possible, on the back side of which the layer of non-transparent material is arranged.

In the region of the cut-outs, this layer has openings or gaps that form the windows. In both cases, the contours of the windows can be very exactly specified and the difference of the light permeability in the region of the windows in comparison to the regions that have the non-transparent material can be chosen to be as large as desired.

In one embodiment, the electronic control is designed to activate the electronic paper so that each of the partial surfaces can have a first degree of reflection that corresponds to an highlighted state of the assigned display element and a second degree of reflection that corresponds to a non-highlighted state of the assigned display element. Which degree of reflection corresponds to the highlighted state depends on the reflection characteristics of the front panel surrounding the display elements. If the first degree of reflection is, for example, a low degree of reflection so that the partial surface appears mainly black, and if the second degree of reflection is a high degree of reflection so that the partial surface appears mainly white, the first degree of reflection corresponds to the highlighted state when a white front panel is used. When a black front panel is used, the second degree of reflection corresponds to the highlighted state. The first degree of reflection can be a minimal degree of reflection and the second degree of reflection can be a maximal degree of reflection of the electronic paper. The use of different shades of gray or different colors is also possible, as long as the electronic paper can display them. In the invention, in particular exactly two different degrees of reflection can be utilized so that it is clearly discernible for each display element whether it is in a selected/highlighted or a non-selected/non-highlighted state.

In one embodiment, the electronic paper has large-format fields, the degree of reflection of which can only be set uniformly, wherein each of the partial surfaces is arranged in one of the large-format fields. The electronic paper can have exactly one electrode for each of the fields on a front side or on a back side of the electronic paper. The degrees of reflection for the entire field can be set via the voltage level on this electrode. This solution leads to the appearance of the partial surfaces being particularly homogeneous, which can be important for a high design quality. In addition, the activation of the electronic paper is simplified significantly in comparison to conventional electronic papers, each of the partial surfaces of which would have hundreds or thousands of separate pixels. The large-format fields can have any shape that can be adapted to the partial surfaces contained in the individual fields and according to the display elements. In particular, the fields can form a rectangular matrix that fills the entire surface of the electronic paper arranged behind the windows. Large-format means that the surfaces of the individual fields correspond at least to the size of the windows in the front panel, which means, depending on the intended purpose, dimensions in the range of, for example, approximately 1 mm up to multiple centimeters. Conventional electronic papers, however, have pixels, the dimensions of which lie in the range of fractions of a millimeter and that are not or almost not individually perceptible at a normal viewing distance. It is understood that multiple partial surfaces can be arranged in the same large-format fields. In this case, all the contained partial surfaces together form a display element, for example a letter composed of multiple lines.

In one embodiment, the fields protrude to the side over contours of the windows. It is thereby achieved that the contours of the associated display element are delimited by the window alone and not by an eventual edge of the associated partial surface.

In one embodiment, the electronic control is designed to refresh the state of an individual partial surface after a specified time has elapsed since this partial surface was last activated, wherein at least one other partial surface is not activated. With electronic paper, the state of the display is maintained for a certain time after a one-time activation. Subsequently, the state of the display must be refreshed in order to prevent a gradual fading of the display. With conventional electronic papers, this refreshing occurs page-wise, i.e., the state of all the display elements is refreshed simultaneously. In the mentioned embodiment, only individual partial surfaces or respectively fields in which these partial surfaces are arranged are refreshed. In particular, exclusively those partial surfaces or fields that are already in danger of fading can be refreshed. The energy consumption accompanying the refreshing can thereby be considerably minimized.

In one embodiment, the electronic control is designed to refresh the state of the display device in specified time intervals and in doing so to activate exclusively those partial surfaces that, at the respective point in time, are either in the highlighted state or in the non-highlighted state. This solution for the refreshing of the display state is useful when the highlighted or respectively the non-highlighted state corresponds to a base state of the electronic paper to which it returns with time. In this case, only fields in the other state that is in danger of returning to the base state need to be refreshed. This measure also lowers the energy consumption of the display device.

In one embodiment, the deviation of a degree of reflection of the front panel from the second degree of reflection lies in the range of 0% to 30%. Through this adaptation of the second degree of reflection to the corresponding degree(s) of reflection of the front panel, it is achieved that the non-selected display elements, the partial surfaces of which have the second degree of reflection, do not or only slightly differ from the front panel in their brightness. The selected display elements, the partial surfaces of which have the first degree of reflection, then differ more clearly in their degree of reflection from the corresponding degree of reflection of the front panel so that they appear highlighted correspondingly clearly. If the adaptation of the second degree of reflection to the degree of reflection of the front panel is not perfect, the non-selected display elements also stay visible at least when viewed exactly. This can be utilized as a design means.

In one embodiment, the front panel has a matte coating. In particular, it can be a matte varnish that prevents disruptive light reflections. At the same time, a degree of reflection of the front panel can be influenced by the matte coating, in particular in order to adapt it to a corresponding second degree of reflection.

In one embodiment, the electronic paper has an anti-reflection coating. This measure counteracts a mirroring reflection on the electronic paper and thereby prevents mirrorings of, for example, a window opposite the display device from interfering with the readability of the display device.

In one embodiment, the display elements are letters, numbers, other symbols or combinations or parts thereof, the shape of which is respectively specified by a contour of one of the windows or by contours of multiple windows. By selecting individual of these display elements from the permanently specified supply, certain contents can be represented. For example, a text can result from a number of selected letters, or number information can result from a number of selected numbers. Using other symbols that first gain meaning in a certain combination is also possible. An example of this is a seven-segment display that has three horizontal and four vertical bars. Each of the bars is a display element. Other display elements can be composed of multiple components, such as, for example, a letter, the lines of which are separated from each other. In this case, the shape of the letter is specified by the contours of multiple windows.

In one embodiment, the windows have structures with an average width that is larger by a factor in the range of 2 to 50 than a material thickness of the front panel or a material thickness of a transparent layer of the front panel. It is thereby achieved that sufficient light falls on the partial surfaces arranged behind the windows in order to ensure good readability of the display elements. If the material thickness of the front panel is too large in comparison to an average width of the structures of the windows, for example in comparison to the line width of a letter, this can lead to a disadvantageous shadowing of the partial surface.

In one embodiment, the display device has a magnetic holder with magnets that are arranged behind the electronic paper and exert an attractive force on the front panel through the electronic paper. For this, the front panel can be made of a magnetic material or can be provided with a magnetic material exclusively in the region of the magnetic holder. The magnets can be arranged, for example, in edge regions of the front panel and/or in middle regions of the front panel. It can thereby be achieved that the front panel optimally abuts the electronic paper everywhere, which is important for the appearance of the display elements. At the same time, a simple and reliable and invisible attachment of the front panel is achieved.

In one embodiment, a selection of the display elements forms a text message, wherein the electronic control is designed to highlight this selection by setting corresponding degrees of reflection for the associated partial surfaces. Accordingly, the display device can be utilized to display text communications.

In one embodiment, the display device is a clock, wherein a selection of the display elements gives the time. This can occur, for example, with the assistance of a seven-segment display, with individual numbers, or in the form of a text message as in the case of word clocks.

The invention is explained in greater detail below based on exemplary embodiments shown in figures. The following is shown:

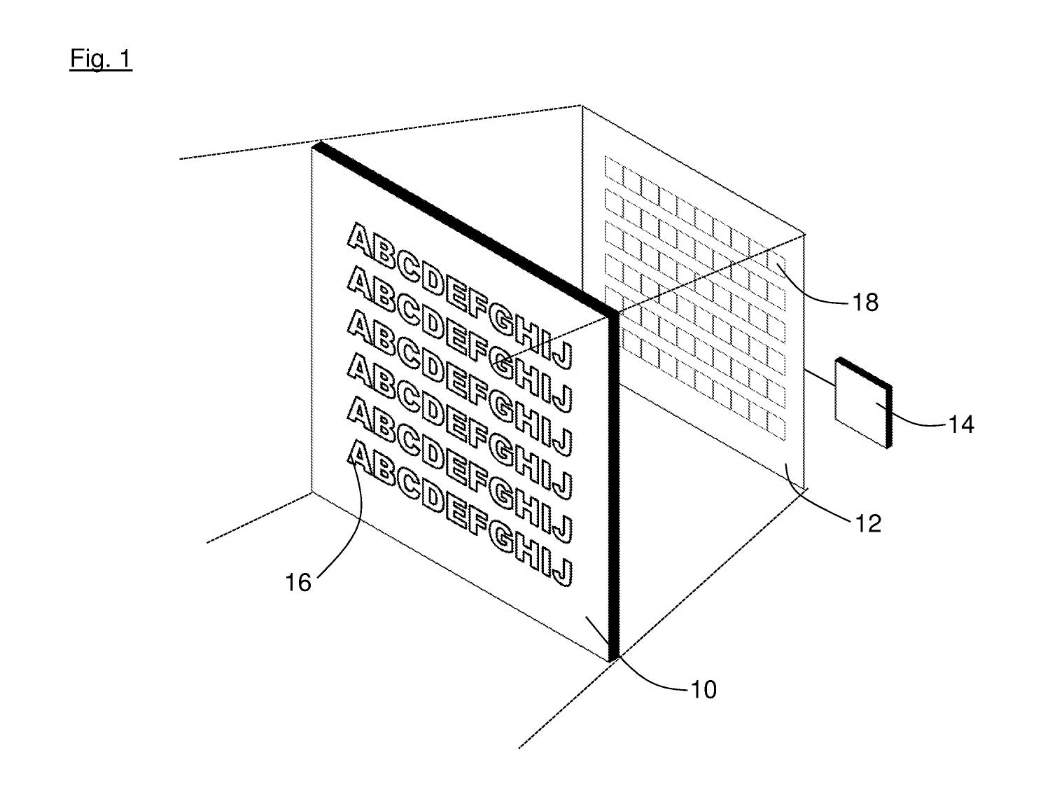

FIG. 1 shows a schematic exploded representation of a display device according to the invention,

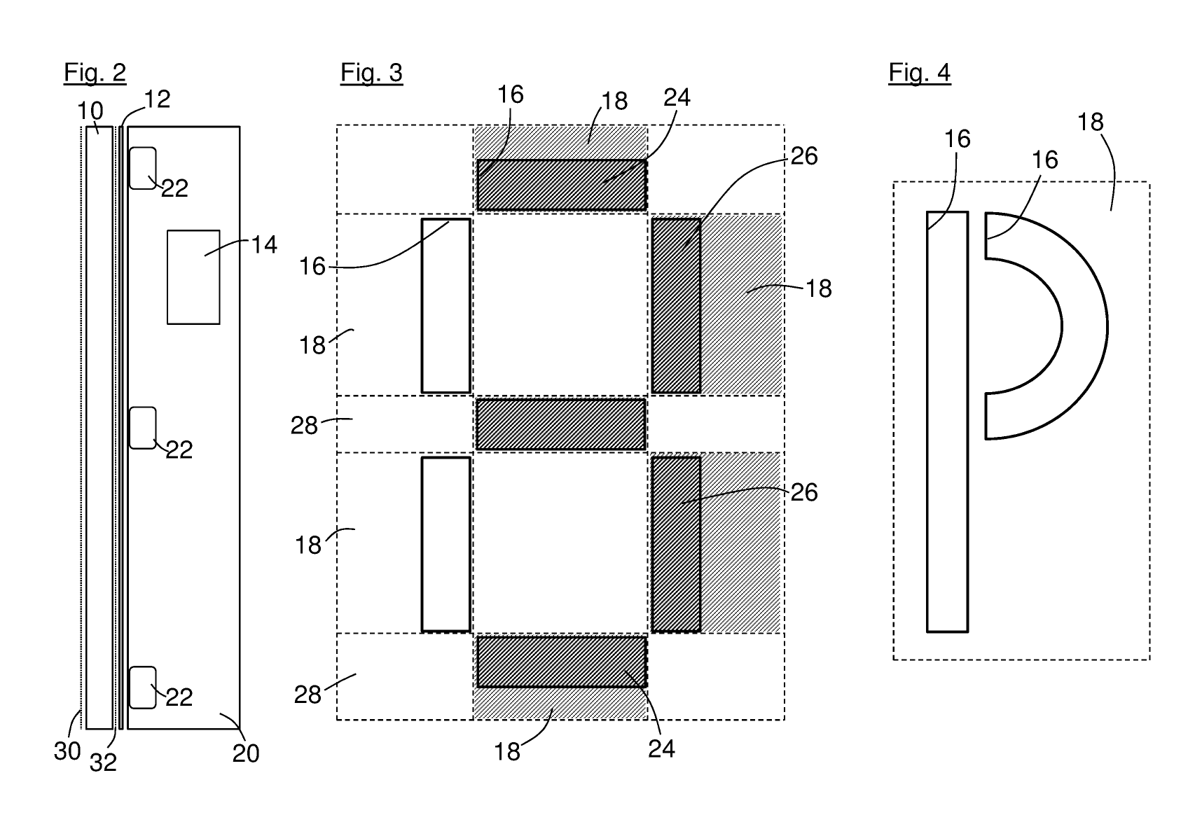

FIG. 2 shows a schematic sectional representation through the display device from FIG. 1,

FIG. 3 shows a part of a front panel with electronic paper behind it in a schematic representation,

FIG. 4 shows a part of another front panel with an electronic paper behind it, also in a schematic representation.

The display device illustrated in FIG. 1 has a front panel 10, an electronic paper 12 and an electronic control 14. The front panel 10 is made of a non-transparent material, for example stainless steel. The dimensions of the front panel 10 in the represented example are approximately 45 cm×45 cm. The material thickness of the front panel 10 is approximately 1 mm.

A plurality of cut-outs that each form a window 16 is arranged in the non-transparent material of the front panel 10. The windows 16 are transparent. In the represented example, each of the windows 16 forms a letter, corresponding to a display element. The windows 16 and accordingly the display elements are arranged in a rectangular matrix with, in the example, six rows and ten columns.

The electronic paper 12 is arranged behind the front panel 10. In the assembled state, the electronic paper 12 is directly behind the front panel 10 so that a front side of the electronic paper 12 abuts a back side of the front panel 10. It is discernible in FIG. 1 that the electronic paper 12 has numerous, rectangular fields 18 that, corresponding to the arrangement of the windows 16 in the front panel 10, are also arranged in a rectangular matrix with six rows and ten columns. Each of the fields 18 comprises a partial surface that is arranged behind one of the windows 16.

The electronic control 14 is connected to the electronic paper 12 and can set the degree of reflection of each individual field 18. The degrees of reflection of the partial surfaces of the electronic paper comprised from the fields 18 that are visible through the windows 16 are thereby also set.

The electronic paper 12 is structured with regard to the activability of the fields 18 so that the degree of reflection of each of the fields 18 can only be set uniformly. For this, on a front side of the electronic paper 12 or on a back side of the electronic paper 12 for each of the fields 18, either exactly one electrode or a group of electrodes can be present that each activate all elements responsible for a certain coloring in the entire field at the same time.

The display device from FIG. 1 can have, in addition to the elements represented in the figure, a back wall 20 or a rear housing element that is arranged behind the electronic paper 12.

Such a back wall 20 is represented in FIG. 2. The schematic view shows a cross-section of the front panel 10, the electronic paper 12 arranged behind, and the back wall 20 arranged behind. The electronic control 14 is arranged within the back wall 20. In addition, three magnets 22 are exemplarily represented that exert an attractive force on the front panel 10 through the electronic paper 12. In this way, the front panel 10 is attached to the back wall 20. At the same time, the arrangement of the electronic paper 12 between the front panel 10 and the back wall 20 is fixed. In particular, it is achieved that the electronic paper 12 abuts the back side of the front panel 10 everywhere. The electronic paper 12 has an anti-reflection coating 32 that extends over the entire front side of the electronic paper 12 and is indicated by a dotted line. A matte coating 30 of the front panel 10 is also indicated by a dotted line that extends over its entire front side.

FIG. 3 shows an example of a part of a display device with a seven-segment display that is designed in a part of a front panel. It has three horizontal bars 24 and four vertical bars 26. The bars 24, 26 are each formed from a cut-out that is a window 16 in the front panel. The electronic paper 12 arranged behind the front panel is visible through these windows 16. In this regard, the division of the electronic paper 12 into a number of rectangular fields 18 with different dimensions is represented in FIG. 3 by the dashed line. It is discernible that each of the windows 16, i.e., each of the bars 24, 26, is arranged in one of the fields 18. In addition, there are some further regions 28 of the electronic paper 12 in which no window 16 is arranged. These can also be designed as fields with an adjustable degree of reflection. This function is, however, not required for the display device so that the further regions 28 of the electronic paper 12 can also be completely without a function.

In the example in FIG. 3, the seven-segment display represents the number 3, for which three of the horizontal bars 24 and two of the vertical bars 26 are highlighted. For this, the electronic control 14 has set the degree of reflection of the associated fields 18 to a first degree of reflection that differs clearly perceptibly from a corresponding degree of reflection of the front side of the front panel 10. In FIG. 3 it is well discernible that the fields 18 are larger than the cut-outs in the front panel forming the bars 24, 26, meaning they protrude over the contours of these cut-outs.

FIG. 4 shows, as another example of a display element, a cut-out of a front panel that has two windows 16 that together form the letter P. As indicated by the dashed line, exactly one field 18 of the electronic paper 12 is behind these two windows.

### LIST OF REFERENCE NUMBERS

10 Front panel

12 Electronic paper

14 Electronic control

16 Window

18 Field

20 Back wall

22 Magnet

24 Horizontal bar

26 Vertical bar

28 Further region

30 Anti-reflection coating

32 Matte coating

1. A display device for displaying a selection of permanently specified display elements with
a front panel that has a plurality of windows that form a number of permanently specified display elements,
an electrophoretic electronic paper that is arranged behind the front panel so that a partial surface of the electronic paper is assigned to each of the windows, and
an electronic control with which a degree of reflection of the electronic paper can be set for each of the partial surfaces.

2. The display device according to claim 1, wherein the front panel is made of a non-transparent material or has a layer of a non-transparent material and the windows are cut-outs in the non-transparent material.

3. The display device according to claim 1, wherein the electronic control is designed to activate the electronic paper so that each of the partial surfaces can have a first degree of reflection that corresponds to an highlighted state of the assigned display element and a second degree of reflection that corresponds to a non-highlighted state of the assigned display element.

4. The display device according to claim 1, wherein the electronic paper has large-format fields, the degree of reflection of which can only be set uniformly, wherein each of the partial surfaces is arranged in one of the fields.

5. The display device according to claim 1, wherein the fields protrude to the side over contours of the windows.

6. The display device according to claim 1, wherein the electronic control is designed to refresh the state of an individual partial surface after a specified time has elapsed since this partial surface was last activated , wherein at least one other partial surface is not activated.

7. The display device according to claim 1, wherein the electronic control is designed to refresh the state of the display device in specified time intervals and in doing so to activate exclusively those partial surfaces that, at the respective point in time, are either in the highlighted state or in the non-highlighted state.

8. The display device according to claim 3, wherein the deviation of a degree of reflection of the front panel from the second degree of reflection lies in the range of 0% to 30%.

9. The display device according to claim 1, the front panel has a matte coating.

10. The display device according to claim 1, wherein the electronic paper has an anti-reflection coating.

11. The display device according to claim 1, wherein the display elements are letters, numbers, other symbols or part thereof, the shape of which is in each case specified by a contour of one of the windows or by contours of multiple windows.

12. The display device according to claim 1, wherein the windows have structures with an average width that is larger by a factor in the range of 2 to 50 than a material thickness of the front panel or than a material thickness of a non-transparent layer of the front panel.

13. The display device according to claim 1, wherein the display device has a magnetic holder with magnets that are arranged behind the electronic paper and exert an attractive force on the front panel through the electronic paper.

14. The display device according to claim 1, wherein the selection of the display elements forms a text message, wherein the electronic control (14) is designed to highlight this selection by setting corresponding degree of reflection for the associated partial surfaces.

15. The display device according to claim 1, wherein the display device is a clock, wherein a selection of the display elements gives the time.
